(19) United States
(12) Patent Application Publication
(10) Pub. No.: US 2025/0265671 A1
(43) Pub. Date: Aug. 21, 2025

(54) SYSTEMS AND METHODS FOR SELECTING LINEUPS OF SQUARE STAKES BASED ON DESIRED PAYOUTS

(71) Applicant: SIDEPRIZE LLC, Atlanta, GA (US)

(72) Inventors: David Adam Wexler, Atlanta, GA (US); Jay Sudarshan Deuskar, Alpharetta, GA (US); Dylan Edward Cooper, Dunwoody, GA (US)

(21) Appl. No.: 19/055,117

(22) Filed: Feb. 17, 2025

Related U.S. Application Data
(60) Provisional application No. 63/553,899, filed on Feb. 15, 2024.

(51) Int. Cl. G06Q 50/34; G07F 17/32

(52) U.S. Cl. CPC G06Q 50/34; G07F 17/3244; G07F 17/3288

(57) ABSTRACT

The disclosed system discussed herein can include systems and methods for analyzing a lineup based on a desired payout multiplier. The disclosed system can determine various options corresponding to the lineup. The disclosed system can receive a selection of a first selected option for the lineup. The disclosed system can filter various remaining options based on the desired multiplier, a respective multiplier of the first selected option, and the respective multiplier for each of the remaining options. The disclosed system can receive at least one selection of at least one additional option for the lineup, wherein the respective multiplier value for each of a plurality of selected options combine to equal the desired multiplier and the plurality of selected options comprises the first selected option and the at least one additional option. The disclosed system can submit the lineup.

### CROSS-REFERENCE TO RELATED APPLICATIONS

This application claims the benefit of, and priority to, U.S. Provisional Patent Application No. 63/553,899, filed on Feb. 15, 2024 and entitled “SYSTEMS AND METHODS FOR SELECTING LINEUPS OF SQUARE STAKES BASED ON DESIRED PAYOUTS,” the entire disclosure of which is incorporated by reference in its entirety as if set forth herein.

### TECHNICAL FIELD

The present disclosure generally relates to systems and methods for staking and, more specifically, to analyzing lineups based on payout selections.

### BACKGROUND

Sports staking, the process of risking money on a sports outcome, has grown in popularity over the last two decades. With the dawn of the internet, the process of staking money on virtual platforms has become a staple for many operators. Operators are defined as entities managing one or more sportsbooks. Square stakes have also grown in popularity over the years. Square stakes can be defined as conditional risks placed on the occurrence or non-occurrence of an event. For example, a square stake can include a conditional risk placed on whether a particular basketball player will or will not score a triple-double (double-digit statistics for three different categories) in a particular contest.

Given that many factors can influence square stakes, operators are less likely to offer them to users interacting with the particular sportsbook. Operators are hesitant to offer lineups of square stakes due to their associated risks. Additionally, it's possible for users to increase their odds of winning based on correlations between two or more square stakes. Given the multitude of factors that the operator must track, it becomes increasingly difficult to accurately assess the factors that can lead to two or more square stakes having some type of correlation, which inherently increases the risk to the operator. Moreover, the operators that do offer lineups of square stakes have no method of allowing users to select their square stakes based on a predetermined payout amount.

Therefore, there is a long-felt but unresolved need for systems and methods that can accurately assess the risk associated with lineups of square stakes and allow users to select square stakes for a lineup based on a desired payout amount.

### BRIEF SUMMARY OF DISCLOSURE

Briefly described, and in various embodiments, the present disclosure generally relates to systems and methods for forming square stake lineups based on a desired payout multiplier. The disclosed system can include a computing infrastructure for processing, administering, and providing a virtual infrastructure for forming square stake lineups based on the desired payout multiplier. The disclosed system can include a computing environment, a client device, and various external resources.

The client device of the disclosed system can include a computer, a laptop, a desktop, a tablet device, a cellular device, and/or any other system capable of communicating with the computing environment. The client device can render a user interface such that a user can select players for square stakes. Square stakes can be defined as conditional risks (e.g., the act of placing money on a particular outcome) placed by the user on a particular outcome associated with a particular event. For example, the square stake can include a stake made on a soccer player scoring greater than 2.5 goals in a single contest. The square stake can include two or more selectable outcomes. For example, the square stake can include a first outcome defined as a greater selection. The greater selection can imply that the user places a conditional risk on the event in which the soccer player scores greater than 2.5 goals. In another example, the square stake can include a second outcome defined as a lesser selection. The lesser selection can imply that the user places a conditional risk on the event in which the soccer player scores less than 2.5 goals.

The user can select, through the user interface a payout multiplier for their associated lineup. By selecting the payout multiplier, the computing environment can allow the user to select various players for their particular square stake lineup based on the desired payout multiplier. As the user makes selections, the computing environment can analyze the particular selection. The computing environment can reject various players from subsequent selection in the lineup based on the previous player selection and or probabilities associated with the associated lineup. For example, the user, through the user interface, can select a first player and their associated event for a two player lineup. Based on the initial selection, the computing environment can analyze various other players for potential subsequent selection for the two player lineup. The computing environment can generate risk scores, generate correlation scores, generate respective multiplier values, and/or generate other probabilistic scores to determine the acceptance or denial of the lineup. For example, the first selected player can include a first respective multiplier value. Continuing this example, the computing environment can sum the first respective multiplier value with each respective multiplier value for the remaining unselected players. The processing service can reject a combination of players for a lineup (e.g., the first selected player and a subsequently selected player) that leads to a sum of the first respective multiplier with a subsequent respective multiplier unequal to the desired payout multiplier. The processing service can accept a combination of players for a lineup that leads to a sum of the first respective multiplier with the subsequent respective multiplier equal to the desired multiplier. The user, through the user interface, can continue to select available players for lineups based on the selectable players rendered by the computing environment.

The computing environment can access external resources to gather data associated with players, stakes, lineups, weather, third-party data, and/or any other data that is associated with the disclosed system.

According to a first aspect, a system, comprising: A) a data store; and B) at least one computing device in communication with the data store, wherein the at least one computing device is configured to: 1) determine a desired multiplier corresponding to at least one lineup for a particular user account; 2) determine a plurality of options corresponding to the at least one lineup, wherein each of the plurality of options are associated with a respective multiplier value; 3) receive a selection of a first selected option of the plurality of options for the at least one lineup; 4) filter a plurality of remaining options of the plurality of options based on the desired multiplier, the respective multiplier of the first selected option, and the respective multiplier for each of the plurality of remaining options; 5) receive at least one selection of at least one additional option from the plurality of remaining options for the at least one lineup, wherein the respective multiplier value for each of a plurality of selected options combine to equal the desired multiplier and the plurality of selected options comprises the first selected option and the at least one additional option; and 6) enter the at least one lineup for the particular user account with the plurality of selected options.

According to a further aspect, the system of the first aspect or any other aspect, wherein the at least one computing device is further configured to in response to receiving the at least one additional option, further filter the plurality of remaining options based on the desired multiplier, the respective multiplier of the first selected option, the respective multiplier for the at least one additional option, and the respective multiplier for each of the plurality of remaining options.

According to a further aspect, the system of the first aspect or any other aspect, wherein the at least one computing device is further configured to: A) determine a first multiplier threshold based on dividing the desired multiplier by the respective multiplier of the first selected option; and B) filter the plurality of remaining options of the plurality of options by removing a subset of the plurality of remaining options with respective multipliers that fail to meet the first multiplier threshold.

According to a further aspect, the system of the first aspect or any other aspect, wherein the at least one computing device is further configured to: A) determine a second multiplier threshold based on dividing the desired multiplier by the respective multiplier of the first selected option; and B) filter the plurality of remaining options of the plurality of options by removing a subset of the plurality of remaining options with respective multipliers that fail to meet the second multiplier threshold.

According to a further aspect, the system of the first aspect or any other aspect, wherein the first multiplier threshold comprises an upper multiplier limit threshold and the second multiplier threshold comprises a lower multiplier limit threshold.

According to a further aspect, the system of the first aspect or any other aspect, wherein the at least one computing device is further configured to combine the respective multiplier value for each of the plurality of selected options by multiplying the respective multiplier value for each of the plurality of selected options together.

According to a further aspect, the system of the first aspect or any other aspect, wherein the at least one computing device is further configured to filter a plurality of remaining options of the plurality of options based on a correlation score, wherein the correlation score defines a correlation coefficient between a two or more options.

According to a further aspect, the system of the first aspect or any other aspect, wherein the at least one computing device is further configured to reject a combination of the two or more options in response to identifying that the correlation score falls above a correlation score threshold.

According to a further aspect, the system of the first aspect or any other aspect, wherein the at least one computing device is further configured to filter a plurality of remaining options of the plurality of options based on a risk score, wherein the risk score quantitates an amount of risk incurred by an operator.

According to a further aspect, the system of the first aspect or any other aspect, wherein the at least one computing device is further configured to reject a subset of the plurality of options in response to identifying that the risk score falls above a risk score threshold.

According to a second aspect, a method, comprising: A) receiving, via at least one computing device, a selection of a desired multiplier corresponding to at least one lineup for a particular user account; B) determining, via the at least one computing device, a plurality of options corresponding to the at least one lineup, wherein each of the plurality of options are associated with a respective multiplier value; C) determining, via the at least one computing device, a first selected option of the plurality of options for the at least one lineup; D) filtering, via the at least one computing device, a plurality of remaining options of the plurality of options based on the desired multiplier, the respective multiplier of the first selected option, and the respective multiplier for each of the plurality of remaining options; E) determining, via the at least one computing device, at least one selection of at least one additional option from the plurality of remaining options for the at least one lineup, wherein the respective multiplier value for each of a plurality of selected options combine to equal the desired multiplier and the plurality of selected options comprises the first selected option and the at least one additional option; and F) entering, via the at least one computing device, the at least one lineup for the particular user account with the plurality of selected options.

According to a further aspect, the method of the second aspect or any other aspect, further comprising generating, via the at least one computing device, a plurality of additional lineups individually comprising a respective plurality of selected options of the plurality of options with respective multiplier values that combine to equal the desired multiplier.

According to a further aspect, the method of the second aspect or any other aspect, wherein a respective count of the respective plurality of selected options for each of the plurality of additional lineups is a same quantity.

According to a further aspect, the method of the second aspect or any other aspect, wherein the at least one lineup has a payout value of the desired multiplier times a monetary amount.

According to a further aspect, the method of the second aspect or any other aspect, wherein determining the first selected option and the at least one additional option comprising randomly selecting, via the at least one computing device, the first selected option and the at least one additional option one at a time from an increasingly reduced subset of the plurality of options that meeting a threshold criteria for achieving the desired multiplier.

According to a third aspect, a non-transitory computer-readable medium embodying a program that, when executed by at least one computing device, causes the at least one computing device to: A) determine a desired multiplier corresponding to at least one lineup for a particular user account; B) determine a plurality of options corresponding to the at least one lineup, wherein each of the plurality of options are associated with a respective multiplier value; C) receive a selection of a first selected option of the plurality of options for the at least one lineup; D) filter a plurality of remaining options of the plurality of options based on the desire multiplier, the respective multiplier of the first selected option, and the respective multiplier for each of the plurality of remaining options; E) receive at least one selection of at least one additional option from the plurality of remaining options for the at least one lineup, wherein the respective multiplier value for each of a plurality of selected options combine to equal the desired multiplier and the plurality of selected options comprises the first selected option and the at least one additional option; and F) enter the at least one lineup for the particular user account with the plurality of selected options.

According to a further aspect, the non-transitory computer-readable medium of the third aspect or any other aspect, wherein a first player associated with the first selected option is associated with a first entity and the at least one additional option is associated with a second entity, the second entity differing from the first entity.

According to a further aspect, the non-transitory computer-readable medium of the third aspect or any other aspect, wherein one of the plurality of options comprises a particular threshold statistic for a particular player in a particular contest.

According to a further aspect, the non-transitory computer-readable medium of the third aspect or any other aspect, wherein the program further causes the at least one computing device to generate a user interface comprising the plurality of remaining options, wherein the at least one selection is received via the user interface.

According to a further aspect, the non-transitory computer-readable medium of the third aspect or any other aspect, wherein the program further causes the at least one computing device to deactivate one or more filtered options of the plurality of remaining options in the user interface.

These and other aspects, features, and benefits of the claimed innovation(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates a player selection interface, according to one example of the disclosed systems and methods;

FIG. 2 illustrates a networked environment, according to one example of the disclosed systems and methods;

FIG. 3 illustrates a schematic block diagram of a computing environment, according to one example of the disclosed systems and methods; and

FIG. 4 illustrates a flowchart of a process, according to one example of the disclosed system and methods.

### DETAILED DESCRIPTION

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

User. A consumer interacting with the particular product.

Operator. An entity representing a contest and/or sportsbook operator or a contest organizer.

Conditional risk. Something such as a sum of money risked on a particular outcome of an uncertain event.

Stake. A single conditional risk made by a user with the operator.

Lineup. A plurality of stakes combined into one.

Square Stake. A type of stake where a conditional risk on an individual player or specific event is made instead of a team or a plurality of events.

Sportsbook. A place where the user can place at least one stake on various sports.

Offer. A submission of a conditional risk, stake, or lineup made to the Sportsbook.

Odds. A chance of a particular outcome for a future event.

Correlation. The degree to which two or more quantities are quantitatively related to one another.

Correlation Value. A measurement of correlation which may be a number between 1and −1. A number close to 1 may mean two factors are positively correlated (e.g., they may rise or fall together and at a similar magnitude), a number close to −1 may mean the two factors are oppositely correlated (e.g., they may rise or fall oppositely and at a similar magnitude), and a number closer to 0 may mean that the two factors may be mostly random to each other, therefore not significantly correlated.

Related Contingencies. Any lineup stake within a correlation value that is not equal to zero (e.g., a related contingency may be any stake that has any sort of dependent event).

Payout. An amount of value, relative to the initial stake and/or lineup, which will be rewarded upon a win.

### Overview

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for forming square stake lineups based on a desired payout multiplier. The disclosed system can include a computing infrastructure for processing, administering, and providing a virtual infrastructure for forming square stake lineups based on the desired payout multiplier. The disclosed system can include a computing environment, a client device, and various external resources.

The client device of the disclosed system can include a computer, a laptop, a desktop, a tablet device, a cellular device, and/or any other system capable of communicating with the computing environment. The client device can render a user interface such that a user can select players for square stakes. Square stakes can be defined as conditional risks (e.g., the act of placing money on a particular outcome) placed by the user on a particular outcome associated with a particular event. For example, the square stake can include a stake made on a soccer player scoring greater than 2.5 goals in a single contest. The square stake can include two or more selectable outcomes. For example, the square stake can include a first outcome defined as a greater selection. The greater selection can imply that the user places a conditional risk on the event in which the soccer player scores greater than 2.5 goals. In another example, the square stake can include a second outcome defined as a lesser selection. The lesser selection can imply that the user places a conditional risk on the event in which the soccer player scores less than 2.5 goals.

The user can select, through the user interface a payout multiplier for their associated lineup. By selecting the payout multiplier, the computing environment can allow the user to select various players for their particular square stake lineup based on the desired payout multiplier. As the user makes selections, the computing environment can analyze the particular selection. For example, the computing environment can reject various players from subsequent selection in the lineup based on the previous player selection and or probabilities associated with the associated lineup. For example, the user, through the user interface, can select a first player and their associated event for a two player lineup. Based on the initial selection, the computing environment can analyze various other players for potential subsequent selection for the two player lineup. The computing environment can generate risk scores, generate correlation scores, generate respective multiplier values, and/or generate other probabilistic scores to determine the acceptance or denial of the lineup. For example, the first selected player can include a first respective multiplier value. Continuing this example, the computing environment can sum the first respective multiplier value with each respective multiplier value for the remaining unselected players. The processing service can reject a combination of players for a lineup (e.g., the first selected player and a subsequently selected player) that lead to a sum of the first respective multiplier with a subsequent respective multiplier that was unequal to the desired payout multiplier. The processing service can accept a combination of players for a lineup that lead to a sum of the first respective multiplier with the subsequent respective multiplier that was equal to the desired multiplier. The user, through the user interface, can continue to select available players for lineups based on the selectable players rendered by the computing environment.

The computing environment can employ various player data and conditional risk data to determine a risk score and correlation score for a particular lineup. For example, the computing environment can employ various correlation algorithms to determine the correlation between a first player and their associated event with a second player and their associated event. The computing environment can generate a correlation score to quantify the correlation between two players. The computing environment can attempt to minimize the correlation score such that the two players and their associated events are considered statistically independent from one another. The computing environment can employ the risk score to quantify the amount of risk incurred by the operator running the sportsbook through the computing environment. The computing environment can employ the risk score to reject lineups, reject players for particular lineups, accept lineups, and/or accept players for particular lineups. For example, the computing environment can employ the risk score and the correlation score and compare the risk score and the correlation score with a risk score threshold and a correlation score threshold. The computing environment, in some examples, can reject various players for selection into the lineup for having a risk score and/or correlation score above the risk score threshold and/or the correlation score threshold, respectively.

The computing environment can access external resources to gather data associated with players, stakes, lineups, weather, third-party data, and/or any other data that is associated with the disclosed system. The computing environment can generate various analytics associated with the data generated by the computing environment, the data gathered from the external resources, and the data gathered from the client devices.

### Example Embodiments

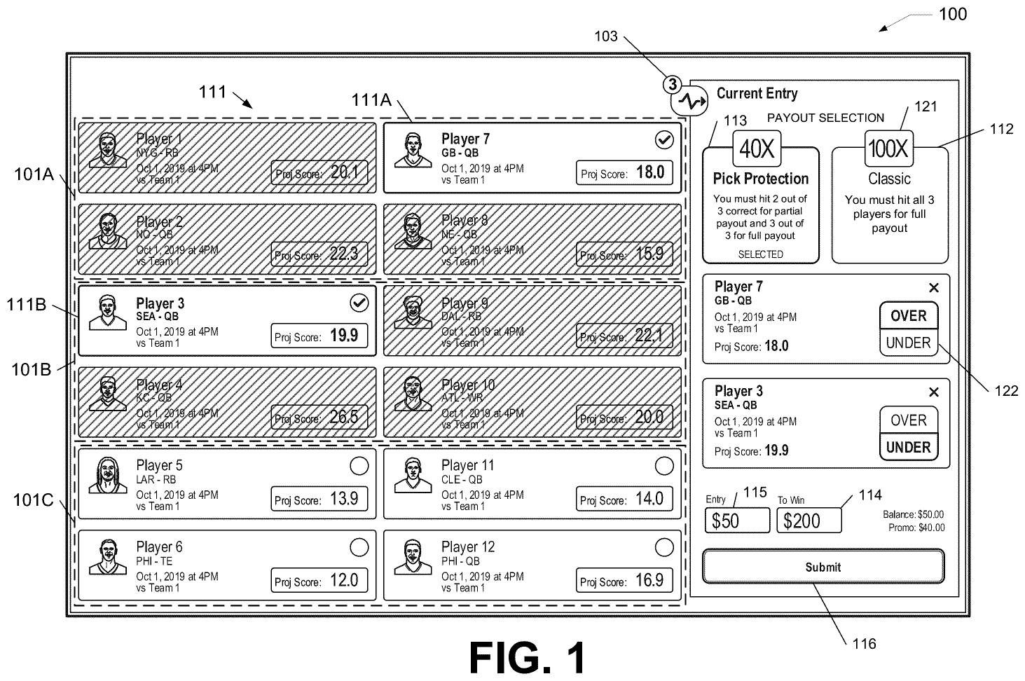

Referring now to the figures, for the purposes of example and explanation of the fundamental processes and components of the disclosed systems and processes, reference is made to FIG. 1, which illustrates an example player selection interface 100. As will be understood and appreciated, the player selection interface 100 shown in FIG. 1 represents merely one approach or embodiment of the present concept, and other aspects are used according to various embodiments of the present concept.

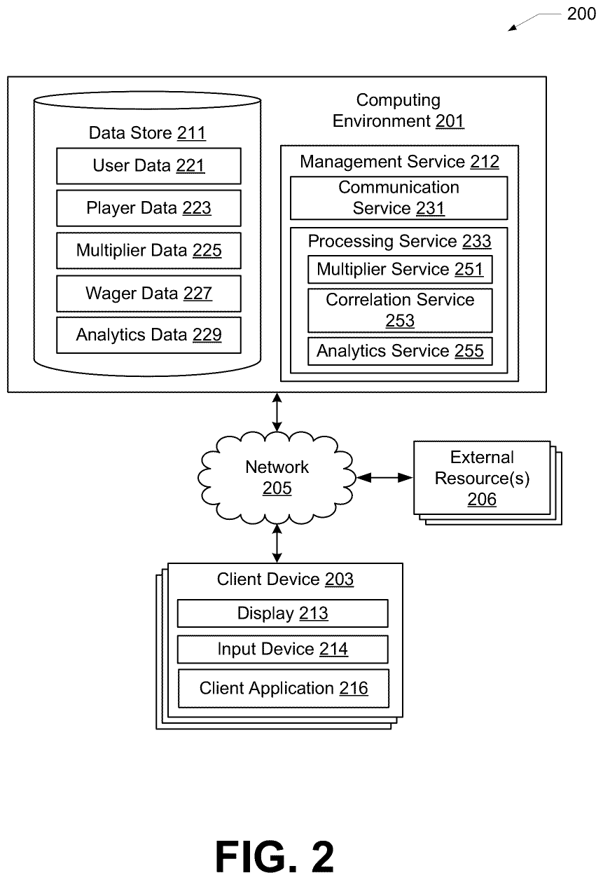

The player selection interface 100 can function as a user interface where users can select players 111 for a stake. The user can interact with the player selection interface 100 through a client device 203 (see FIG. 2). The client device 203 can function as the main source of communication for analyzing players 111, placing various stakes through one or more lineups, receiving payouts 114, and/or performing any other interaction with a computing environment 201 (see FIG. 2). For example, the client device 203 can include a laptop, a desktop, a mobile computer, a cellphone, a video contest console, and/or any particular computing device with web access. The computing environment 201 can function as the central computing source managing the various components and functionalities of a sportsbook for an operator.

The player selection interface 100 can render one or more players 111 with associated events. The players 111 can include any particular individual participating in a sporting event virtually and/or physically (e.g., National Football League (NFL) players, Major League Baseball (MLB) players, National Hockey League (NHL) players, League of Legends players, La Liga players, Champions League players). The players 111 can include one or more players from any sport participating in any league and/or tournament. For example the players 111 can include a soccer player playing in the MLS league and a baseball player playing in the World Series. The player selection interface 100 can render players 111 that are performing on the same day, performing on distinct days, participating in different leagues and/or positions, multiple instances of the same player 111 (e.g., the same player playing in different sporting events, the same player with different associated events), any particular player and associated event, or a combination thereof. The associated events can include any particular event performed by the player 111. For example, the player 111 can include a football quarterback and the associated event can include throwing three touchdowns in a single contest. In another example, the associated event can include a projected fantasy score of 18.0 based on the performance of the player 111 in a particular League of Legends contest. The user can place a conditional risk on the particular players 111 based on the associated event. Placing the conditional risk on the particular players 111 based on the associated event can be referred to as a square stake. When placing a conditional risk 115 on two or more stakes for two or more distinct players 111, the combination of the two or more stakes can be considered a lineup.

The player selection interface 100 can render a request for the user to select an outcome 122 based on the associated event. The outcome 122 can include at least two selectable results of the associated event. For example, the outcome 122 can include the greater selection and a lesser selection. In another example, the outcome 122 can include an occurrence selection and a non-occurrence selection. The player selection interface 100 can receive a greater selection from the user indicating that the particular quarterback will throw greater than three touchdowns in the next contest. The outcome 122 can include more than two selectable outcomes. For example, the outcome 122 can include the greater selection, the lesser selection, and a hit selection, where the greater selection can indicate a prediction that the player 111 will perform greater than the associated event (e.g., receive more than 18.0 fantasy points), the lesser selection can indicate a prediction that the player 111 will perform below the associated event (e.g., receive less than 18.0 fantasy points), and the hit selection can indicate a prediction that the player 111 will perform the exact associated event (e.g., receive equal to 18.0 fantasy points).

The player selection interface 100 can render a lineup selection 103. The lineup selection 103 can define the lineup size. For example, a three stake lineup can include choosing three distinct players 111 and their associated events and placing a conditional risk (e.g., risk money) on the combined outcome of each outcome 122 selected for each particular player 111 and their associated events. The lineup 103 can include more than one stake. For example, the lineup can include two stakes, three stakes, four stakes, five stakes, six stakes, and/or any particular number of stakes greater than one. By increasing the number of players 111 selected for a single lineup, a payout 114 can increase in value. For example, selecting more than one player 111 for the single lineup can decrease the probability that all outcomes 122 for each selected player 111 are correctly chosen. Continuing this example, to increase the appeal of the inherent lower probability of successfully choosing all outcomes 122 correctly in the single lineup, the payout 114 can increase in value. The payout 114 can be equal to the conditional risk 115 multiplied by a payout multiplier 121. The computing environment 201 can change the size of the lineup selection 103 on receiving an input (e.g., a numerical text input) defining the lineup size (e.g., 2 stake lineup, 3 stake lineup, 4 stake lineup) or by dynamically changing the lineup size as the user selects subsequent players 111 to add into the single lineup.

The user can select from two distinct lineup types: a classic lineup type 112 or a pick protection lineup type 113. Although not illustrated, other types of lineup payout structures can be employed. The classic lineup type 112 can define a lineup type where every selected outcome 122 for each selected player 111 must be correct in order for the user to receive the full payout 114 as defined by the payout multiplier 121. The pick protection lineup type 113 can define a lineup type where the payout multiplier 121 dynamically changes based on the number of correct outcomes 122 chosen for each of the players 111 in the single lineup. For example, in the pick protection lineup type 113 and where the lineup includes three players 111 and three associated outcomes 122, the payout multiplier 121 can equal a maximum of 4.0 times the conditional risk 115 when all three outcomes 122 are correctly selected, 1.4 times the conditional risk 115 when two of the three outcomes 122 are correctly selected, 0.4 times the conditional risk 115 when one of the three outcomes 122 are correctly selected, and 0.0 times the conditional risk 115 when zero of the three outcomes 122 are correctly selected. In another example, on selecting the classic lineup type 112, the payout multiplier 121 can equal a maximum of 10.0 times the conditional risk 115 when all the outcomes 122 are correctly selected and 0.0 when at least one outcome 122 of the selected outcomes 122 is incorrectly selected.

The player selection interface 100 can allow users to select their desired payout multiplier 121. The payout multiplier 121 can be defined as the multiple used to calculate the payout 114 when a winning condition for the particular stake is met. The payout multiplier 121 can vary based on various factors, including, conditional risk type (e.g., one stake, lineups, spreads, etc.), odds of a successful winning a conditional risk, correlations between stakes in a lineup, payout structure, and/or any other factor discussed herein. For example, the payout multiplier 121 can define the amount the conditional risk 115 will be multiplied by to generate the payout 114 on determination that the user has correctly satisfied the winning conditions defined by the particular conditional risk type.

On selecting the pick protection lineup type 113 or the classic lineup type 112, the user can select their desired payout multiplier 121. In one example, the player selection interface 100 can render a drop-down menu that lists a finite number of payout multipliers 121 selectable by the user. In another example, the player selection interface 100 can render a text input box where the user can input through the client device 203 a desired numerical value for the payout multiplier 121. In some embodiments, the player selection interface 100 can include a range of acceptable payout multipliers 121 where the user can increase or decrease the lower and/or upper bounding multipliers.

As discussed in further detail herein, the computing environment 201 can determine various selectable players 111 based on the payout multiplier 121. For example, the player selection interface 100 can render a first subset 101A of players 111, a second subset 101B of players 111, and a third subset 101C of players 111. The first subset 101A, the second subset 101B, and the third subset 101C can all include the same and/or distinct players 111 and associated events. The computing environment 201 can allow the user to select a first player 111A out of three particular players 111 from the first subset 101A, the second subset 101B, and/or the third subset 101C to form a three stake lineup. On selecting the first player 111A, the computing environment 201 can narrow down the selectable players 111 for the remaining picks in the three stake lineup by disabling one or more players 111 from the first subset 101A, the second subset 101B, and/or the third subset 101C.

The computing environment 201 can determine a required number of players 111 for the particular lineup based on the selected payout multiplier 121. For example, the computing environment 201 can determine that there is no combination of three stake lineups that can adequately support the payout multiplier 121. The computing environment 201 can determine that the lineup must include a minimum of five players 111 to satisfy the selected payout multiplier 121.

The computing environment 201 can disable particular players 111 from the first subset 101A, the second subset 101B, and/or the third subset 101C based on the selected payout multiplier 121. For example, a conditional risk can include a risk score. The risk score can quantify the risk incurred by the operator. Further continuing this example, the payout multiplier 121 can include a risk score threshold. The risk score threshold can define the maximum amount of risk the operator is willing to incur from the conditional risk, stake, and/or lineup. The computing environment 201 can calculate the risk score and/or risk score threshold based on the outcomes 122 associated with the particular players 111, the correlations between two or more players 111, the conditional risk type selected, and/or any other factor that can affect the risk incurred by the operator. On determining that one or more players 111 combined with the first player 111A generate a risk score above the risk score threshold, the computing environment can disable the selection of the one or more players 111.

On selecting the first player 111A and the computing environment 201 disabling various players 111 for subsequent selection, the user can select a second player 111B. The computing environment 102 can allow the selection of the second player 111B because the combination of the first player 111A and the second player 111B do not place the risk score above the risk score threshold. After selecting the first player 111A and the second player 111B, the computing environment 201 can reprocess the risk score to assess how any subsequent player 111 selected for the three stake lineup would affect the risk score. The computing environment 201 can further disable various players 111 for subsequent selection if their selection would place the risk score above the risk score threshold. For example, the computing environment 201 can disable various players 111 from the second subset 101B after the selection of the first player 111A and the second player 111B. The user can make a final selection from the third subset 101C to complete the three player lineup.

On completing player selections for the three player lineup, the user can select their desired outcomes 122 for each particular player. The player selection interface 100 can render a text box for entering the conditional risk 115 through the client device 203. The player selection interface 100 can render a drop-down menu for selecting the conditional risk 115 from various predetermined conditional risks 115. The player selection interface 100 can calculate a potential payout 114, where the potential payout 114 equates to the conditional risk 115 multiplied by the maximum payout multiplier 121 associated with the lineup type and entered by the user. Player selection interface 100 can render a submit button 116. The client device 203 can receive a selection of the submit button 116 once the user is satisfied with their particular lineup.

Referring now to FIG. 2, illustrated is a networked environment 200 according to various embodiments of the present disclosure. The networked environment 200 can include a computing environment 201, a client device 203, and an external resource(s) 206, which can be in data communication with each other via a network 205. The network 205 can include, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, Bluetooth networks, Wi-Fi networks, NFC networks, and other types of networks.

The computing environment 201 can include, for example, a server computer or any other system providing computing capability. Alternatively, the computing environment 201 can employ more than one computing devices that can be arranged, for example, in one or more server banks or computer banks or other arrangements. Such computing devices can be located in a single installation or can be distributed among many different geographical locations. For example, the computing environment 201 can include one or more computing devices that together can include a hosted computing resource, a grid computing resource, and/or any other distributed computing arrangement. In some cases, the computing environment 201 can correspond to an elastic computing resource where the allotted capacity of processing, network, storage, or other computing-related resources can vary over time.

The computing environment 201 can function as the centralized computing source for managing and processing the functionalities of the sportsbook for the particular operator. For example, the computing environment 201 can receive lineups and/or stakes, process the lineups and/or stakes, determine the outcome 122 of the particular lineups and/or stakes, distribute payouts 114, analyze data associated with the particular sportsbook, generate and render the first player user interface 100, and/or manage any particular functionality of the sportsbook for the particular operator. In some embodiments, the functionalities of the computing environment 201 will be discussed in further detail herein.

Various applications and/or other functionality can be executed in the computing environment 201 according to various embodiments. Also, various data can be stored in a data store 211 that can be accessible to the computing environment 201. The data store 211 can be representative of one or more of data stores 211 as can be appreciated. The data stored in the data store 211, for example, can be associated with the operation of the various applications and/or functional entities described below.

The data stored in the data store 211 can includes, for example, a list of data, and potentially other data. The data store 211 can include user data 221, player data 223, multiplier data 225, conditional risk data 227, and analytics data 229.

The user data 221 can include any data pertaining to the user. The user data 221 can include but is not limited to an email, a username, a password, an address, a social security number, a birth date, a verified identification (e.g., a driver's license, a passport, a birth certificate), an Internet Protocol (IP) address, Media Access Control (MAC) address associated with the one or more client devices 203, banking information, social media information, alternate account login information (e.g., Apple login information, Google login information) financial information, tax information, and/or any other information associated with the user. The user data 221 can be received by the computing environment 201 from the client device 203 and/or the external resources 206.

The player data 223 can include any data associated with the one or more players 111. The player data 223 can include but is not limited to a player's name, a player's team, a player's sport, a player's position, a player's performance statistics, a player's teammates, a player's associated leagues and/or competitions, a player's associated events, a location of the player's sporting event, competitors associated with the player, weather associated with the sporting event of the player, a player's historical performance, analytics data associated with the player, and/or any other information associated with the player 111. The player data 223 can include data gathered, processed, and/or analyzed by the computing environment 201. The computing environment 201 can extract player data 223 from the one or more external resources 206. For example, the player data 223 can include all performance data associated with the player 111 and gathered from one or more external resources 206 (e.g., external statistics websites, external sporting event data, external staking data).

The multiplier data 225 can include any data associated with the payout multiplier 121. For example, the multiplier data 225 can include but is not limited to predetermined multipliers for different lineup types, multiplier rules, risk scores, risk score thresholds, correlation scores, correlation thresholds, and/or any data for determining the payout multipliers 121. The multiplier rules can include any rules that govern the determination of the payout multiplier 121. For example, the multiplier rules can include a probability to multiplier conversion ratio, where the probability to multiplier conversion ratio can define the rate at which the payout multiplier 121 changes relative to the probability of a successful outcome 122 for a particular conditional risk. In another example, the multiplier rules can include a multiplier tolerance range. The multiplier tolerance range can define a range of one or more payout multipliers 121 for a range of one or more risk scores. In yet another example, the multiplier rule can include a multiplier threshold, where the multiplier threshold defines the maximum payout multiplier 121 the operator is willing to support for any particular conditional risk and/or stake.

The risk score can include a quantitative value that defines the risk the operator is incurring based on the particular conditional risk. For example, the risk score can include a value from 0 to 100 where 0 indicates a 0% risk to the operator and 100 indicates a 100% risk to the operator. The risk score can include a value representative of the correlation score, the probability that the outcome 122 is successfully chosen, and/or any other probabilistic data associated with the conditional risk. The risk score threshold can define the total amount of risk the operator is willing to incur. For example, if the risk score is above the risk score threshold for a particular conditional risk, the computing environment 201 can reject the conditional risk. In another example, if the risk score is below the risk score threshold for a particular conditional risk, the computing environment 201 can accept the conditional risk.

The correlation score can define a score that quantifies the correlation between two players 111, their associated events, and the associated outcomes 122. For example, the correlation score can be substantially similar to a correlation coefficient (e.g., Pearson coefficient) for determining the correlation between two players 111, their associated events, and the associated outcomes 122. The correlation score can range from −1 to 1. When the correlation score equates to 1, the correlation score can indicate that a first player and their associated event is positively correlated with a second player and their associated event. For example, a quarterback and their associated event of throwing three touchdowns can be positively correlated with a wide receiver on the same team as the quarterback and their associated event of catching three touchdowns. When the correlation score equates to −1, the correlation score can indicate that a first player and their associated event is negatively correlated with a second player and their associated event. For example, an attacking player on a first soccer team can include an associated event of scoring a goal. Continuing this example, a defensive player on a second soccer team playing the first soccer team can include an associated event of keeping a clean sheet (e.g., not allowing any goals). Further continuing this example, as the likelihood of the attacking player scoring a goal goes up, the likelihood that the defensive player keeping the clean sheet goes down. A correlation coefficient of 0 can indicate that there is no statistical correlation between the particular players 111 and their associated events. For example a first player in a soccer contest in France can have an associated event of scoring two goals, which can be statistically independent and uncorrelated with a second player in a League of Legends match in Canada with an associated event of destroying four tower defenses.

The computing environment 201 can employ any type of correlation coefficient and can calculate the correlation coefficient using any statistical analysis technique, machine learning technique, and/or data processing technique. The correlation coefficient threshold can define a maximum correlation coefficient amount that the computing environment 201 will allow for a particular conditional risk. For example, the computing environment 201 can calculate the absolute value of the correlation coefficient. Continuing this example, if the correlation coefficient falls below the correlation coefficient threshold, the computing environment 201 can allow the conditional risk associated with the particular correlation coefficient. Further continuing this example, if the correlation coefficient is above the correlation coefficient threshold, the computing environment 201 can disallow the conditional risk associated with the particular correlation coefficient.

The conditional risk data 227 can include any data associated with conditional risks of one or more users interacting with the computing environment 201. For example, the conditional risk data 227 can include but is not limited to historical conditional risks, successful conditional risks, unsuccessful conditional risks, historical conditional risks 115, and/or any other information associated with a conditional risk performed in the networked environment 200. The conditional risk data 227 can include the conditional risks 115 offered by the user and their associated payout amounts 114.

The analytics data 229 can include any data generated, processed, and/or analyzed by the computing environment 201. For example, the analytics data 229 can include but is not limited to the most successful conditional risks (e.g., players 111 and their associated outcomes 122), the least successful conditional risks (e.g., players 111 and their associated outcomes 122), user retention statistics, and/or any other data that can be generated by the computing environment 201 to analyze a particular aspect of the sportsbook.

The components executed on the computing environment 201, for example, can include list of applications, and other applications, services, processes, systems, engines, or functionality not discussed in detail herein. The computing environment 201 can include a management service 212. The management service 212 can function as the central computing infrastructure for the computing environment 201. The management service 212 can include a communication service 231 and a processing service 233.

The communication service 231 can perform any particular communication interaction for the computing environment 201. For example, the communication service 231 can facilitate a communication between the communication service 231 and at least one of the client device 203, the external resource(s) 206, and/or any other systems distributed across the network 205. The communication service 231 can distribute data internally for the computing environment 201. For example, the communication service 231 can receive various data from the client device 203 and/or the external resources 206 and organize the data into the data store 211. In another example, the communication service 231 can distribute data to the processing service 233 on receiving a request for data from the processing service 233. The computing environment 201 can send data to any particular resources on the networked environment 200.

The processing service 233 can perform any particular calculation, analysis, and/or data processing technique for the computing environment 201. The processing service 233 can include a multiplier service 251, a correlation service 253, and an analytics service 255. The processing service 233 can determine various probabilities associated with the one or more players 111 and their respective outcomes 122. For example, the processing service 233 can perform statistical analyses to determine the probability that a quarterback throws less than three touchdowns, more than three touchdowns, and/or equal to three touchdowns. Based on the risk score, the correlation score, statistical analyses, and/or any other data from the multiplier data 225, the processing service 233 can enable and/or disable players 111 for selection based on the payout multiplier 121. The processing service 233 can perform various functionalities discussed in further detail herein.

The multiplier service 251 can perform any particular calculations related to the payout multiplier 121. For example, the multiplier service 251 can calculate various multiplier data 225 such as the risk scores associated with the payout multipliers 121. In another example, the multiplier service 251 can calculate probabilities associated with the various players 111 and their particular outcomes 122. In another example, the multiplier service 251 can generate decision trees mapping different lineups with different combinations of player 111 to compare payout multipliers 121. In another example, the multiplier service 251 can analyze historical payout multiplier 121 data. In another example, the multiplier service 251 can perform any calculations associated with the payout multiplier 121.

The correlation service 253 can calculate various correlation scores for any stake and/or lineup. The correlation service 253 can aggregate player data 223 from the data store 211 using the communication service 231. The correlation service 253 can determine a correlation between two players 111 and their associated event by calculating the correlation coefficient between the two players 111. For example, the correlation service 253 can aggregate historical player data for both players 111 and compare the various statistical metrics to generate various linear regressions. Continuing this example, the correlation service 253 can determine a correlation coefficient based on the one or more linear regressions between the various statistical metrics of the two players 111. The correlation service 253 can employ machine learning techniques to determine the correlation score between two players 111 and their associated outcomes 122. For example, the correlation service 253 can employ support vector machines (SVM), random forest models, neural networks, linear regression models, and/or K-nearest neighbor model for determine the correlation coefficient and/or any other correlation metric between two or more players 111. The correlation service 253 can generate correlation scores for two or more players 111. For example, the correlation service 253 can generate correlation scores between three players 111, each independently compared to one another and/or again as a total group.

The analytics service 255 can perform any particular analytical process for the computing environment 201. For example, the analytics service 255 can process various statistics on the conditional risks, stakes, lineups, players 111, and/or outcomes 122 to generate insights associated with the sportsbook. The analytics service 255 can determine the most successful conditional risks associated with a particular player 111. For example, the analytics service 255 can aggregate historical conditional risk earnings data for one or more users to determine the conditional risks that lead to the greatest returns. The analytics service 255 can track user retention rate based on a number of conditional risks placed by the user, an amount of money deposited by the user, number of logins by the user over a particular period of time, and/or any other metric. For example, the analytics service 255 can generate a report that analyzes and ranks various promotional events (e.g., conditional risk matching, double payout multiplier events, happy hour events, etc.) based on their ability to retain users (e.g., increase average number of logins for various users.

The client device 203 can be representative of a one or more client devices that can be coupled to the network 205. The client device 203 can include, for example, a processor-based system such as a computer system. Such a computer system can be embodied in the form of a desktop computer, a laptop computer, personal digital assistants, cellular telephones, smartphones, set-top boxes, music players, web pads, tablet computer systems, contest consoles, electronic book readers, or other devices with like capability. The client device 203 can include a display 213. The display 213 can include, for example, one or more devices such as liquid crystal display (LCD) displays, gas plasma-based flat panel displays, organic light emitting diode (OLED) displays, touch sensitive displays, electrophoretic ink (E ink) displays, LCD projectors, or other types of display devices, etc.

The client device 203 can be configured to execute various applications such as a client application 216 and/or other applications. The client application 216 can be executed in a client device 203, for example, to access network content served up by the computing environment 201 and/or other servers. The client application 216 execute through the client device to render the player selection interface 100 on the display 213. To this end, the client application 216 can include, for example, a browser, a dedicated application, etc., and the client application 216 can include a network page, an application screen, etc. The client device 203 can execute applications beyond the client application 216 such as, for example, email applications, social networking applications, word processors, spreadsheets, and/or other applications.

The client device 203 can include a laptop, a desktop, a gaming console, a cellular device, a tablet, and/or any other electronic computing device that can interact with the network 205. The client device 203 can include one or more input devices 214. The input devices 214 can include, for example, a keyboard, a mouse, a controller, a trackpad, a stylus, a touch sensitive display, a microphone, a Global Positioning System (GPS) sensor, an identification sensor (e.g., face identification sensor, thumb scanner), a camera, and/or any other particular input.

Next, a general description of potential operations of the various components of the networked environment 200 is provided. To begin, the client application 216 of the client device 203 can function as the central interactive resource between the computing environment 201 and one or more users. The client application 216 can provide functionalities, such as, initiating a login page, receiving user data 221 during a signup procedure, rendering the first player selection interface 100, rendering various analytics data 229 associated with the one or more players 111, managing various settings associated with an account of the user (e.g., changing user data 221), and/or receive conditional risks on various stakes and lineups.

During registration, the client device 203 can employ the GPS sensor and/or any other positioning sensor to determine the geographical location of the user. The client device 203 can relay the GPS sensor data to the computing environment 201 to determine the jurisdiction (e.g., state, country) of the client device 203. The computing environment 201 can deny the registration of the user based on the GPS sensor data. For example, the client device 203 can compare the GPS sensor data to a list of approved jurisdictions. The computing environment 201 can accept the registration of the user if the GPS sensor data is located within one of the approved jurisdictions. The computing environment 201 can deny the registration of the user if the GPS sensor data is located outside of the approved jurisdictions. The computing environment 201 can compare the GPS sensor data to the verified identification and/or home address of the user to confirm the validity of the GPS sensor data. The verified identification and/or home address listed on the verified identification can supersede the GPS sensor data in the case the client device 203 is actively using a Virtual Private Network (VPN) to trick the GPS sensor into providing inaccurate location and or jurisdiction data.

The processing service 233 can generate various predictions of associated events and/or odds of the associated events for one or more players 111. The processing service 233 can employ the player data 223 to determine prediction for the associated events and/or odds of the associated events of the one or more players 111. For example, the processing service 233 can receive player data 223, which can include historical performance data of the particular player 111 and future sporting events of the particular player 111. The processing service 233 can generate odds for the associate events of the various players 111 performing in a specific sporting event. The processing service 233 can analyze various aspects associated with the specific sporting event. For example, the processing service 233 can analyze and/or receive information regarding the particular location of the specific sporting event, the weather present at the specific sporting event, the opposing team participating in the specific sporting event, the injury list of the opposing team, and/or any other factor associated with the specific sporting event of the particular player 111. The processing service 233 can compare the historical performance data of the particular player 111 against the data associated with the specific sporting event. For example, the processing service 233 can calculate various variances, likelihood of occurrences, and/or standard deviations from the historical mean for various outcomes of the associated events (e.g., scoring 1.5 runs, scoring 2.5 runs, scoring 3.5 runs). The processing service 233, based on the comparison of the historical performance data of the player 111 and the data associated with the specific sporting event, can generate a corresponding associated event. The corresponding associated event can include, for example, a particular player 111 scoring 2.5 runs in a baseball contest. Based on the previous example, the processing service 233 can generate a prediction that the particular player will score 2.5 runs in the baseball contest based on, for example, the players 111 historical performance against the opposing team and/or the last ten contest performance of the player 111. The selection of the associated event (e.g., scoring 2.5 runs) can represent the associated event that has the least amount of statistical variance, standard deviation, and/or equal probability of succeeding or failing. The processing service 233 can receive calculated associated events and/or odds from the external resources/services 206 (e.g., third party oddsmakers) for use by computing environment 201.

Once the odds have been determined by the processing service 233, the processing service 233 can render the players 111 and their associated events onto the player selection interface 100. The processing service 233 can analyze various conditional risks 115 placed on the players 111 and their associated events to determine an adjustment to the associated event. For example, the processing service 233 can, in real-time, analyze if there is a significantly larger number of users placing conditional risks 115 on the particular player scoring greater than 2.5 run as compared to other users placing conditional risks 115 on the particular player scoring less than 2.5 runs. The processing service 233 can, in real-time, adjust the associated event to reflect the demand for the greater selection of the outcomes 122. For example, for any subsequent conditional risks 115, the processing service 233 can increase the associated event to 4.5 runs for the particular player 111. The processing service 233 can analyze the demand of the particular outcomes 122 using proprietary resources, third-party resources, and/or any particular data associated with the conditional risks placed on various outcomes 122.

The computing environment 201 can receive conditional risk data 227 from the client device 203. For example, on initiating the player selection interface 100, the client device 203 can form a connection with the computing environment 201. The client device 203 can send conditional risk data 227 and/or multiplier data 225 in real time to the computing device. The conditional risk data 227 can include real-time selections for player 111, real-time lineup size and type, real-time selections for outcome 122, real-time inputs for conditional risk 115, and/or any other information generated through the player selection interface 100.

On determining initial odds for the players 111 and their associated events, the processing service 233 can publish the players 111 and their associated events to the player selection interface 100. The client device 203 can begin the process of selecting various players 111 for a particular lineup. For example, the client device 203 can render the player selection interface 100 onto the display 213. Continuing this example, the client device 203 can receive an input through the input device 214 defining the lineup type (e.g., classic lineup type 112, pick protection lineup type 113) and a desired payout multiplier 121. For example, the client device 203 can send the computing environment 201 a selection for a classic lineup type 112 and a selection of a payout multiplier 121 of 10×.

On receiving the selection of the lineup type and the desired lineup multiplier 121, the processing service 233 can determine the one or more players 111 that will satisfy the lineup multiplier 121. The processing service 233 can employ the multiplier service 251 and the correlation service 253 to determine the one or more players 111 that best fit the desired player multiplier 121. The multiplier service 251 can generate the multiplier data 225 associated with each player 111 and their associated event. For example, the multiplier service 251 can calculate the risk score of the multiplier data 225 by determining a likelihood of occurrence for each outcome 122 for the particular player 111. In another example, the multiplier service 251 can calculate the risk score of the multiplier data 225 by employing the odds associated with the player 111 and their associated event. In yet another example, the multiplier service 251 can calculate the risk score of the multiplier data 225 using the likelihood of occurrence for each outcome 122, the odds associated with the player 111 and their associated event, a standard deviation from the historical mean for the particular player 111, the historical conditional risk statistics associated with the player 111 and their associated event, or a combination thereof. The processing service 233 can employ the multiplier service 251 to calculate the risk score of the multiplier data 225 for each particular player 111 accessible through the player selection interface 100. Each particular payout multiplier 121 can include a respective risk score threshold. The processing service 233 can generate the respective risk score threshold of the multiplier data 225 based on the desires amount of risk the entity is willing to incur for each particular player 111 and their associated event. For example, a first risk score threshold for a 1× payout multiplier 121 can be higher than a second risk score threshold for a 10× payout multiplier 121. Based on the desired payout multiplier 121 and its associated risk score threshold, the processing service 233 can eliminate players 111 from the player selection interface 100 that alone or in combination with other players 111 will place the risk score of the lineup above the risk score threshold.

The processing service 233 can generate decision trees and/or employ any other sequential processing technique to calculate all combination of players 111 that maintain the risk score and the multiplier data 225 of the particular lineup below the risk score threshold associated with the desired payout multiplier 121. For example, the processing service 233 can employ the correlation service 253 to generate the correlation score for each pair of player 111 available for selection by the client device 203 through the player selection interface 100. The correlation score can include any quantitative value that defines the likelihood that either outcome 122 of two particular players 111 will correlate to one another (e.g., have a positive or negative correlation). In various embodiments, any combination of players 111 that have a non-zero correlation score are deemed less desirable for the operator. Any non-zero correlation score can be deemed less desirable for the operator, because the user can increase their odds of choosing a correct outcome 122 based on the correlation. The processing service 233 can integrate the correlation score into the risk score of each particular player 111 (e.g., an individual player risk score). The correlation score can be integrated into a new risk score, stored as multiplier data 225, and calculated between two or more players 111 (e.g., a combined risk score). The processing service 233 can eliminate any particular player 111 based on the individual risk score falling below the risk score threshold of the desired payout multiplier 121. The processing service 233 can eliminate any combination of players 111 based on the combined risk score falling below the risk score threshold of the desired payout multiplier 121.

The processing service 233 can eliminate players 111 from the player selection interface 100 in real-time. For example, the processing service 233 can receive the desired payout multiplier 121 and calculate various risk scores and correlation scores accordingly. The processing service 233 can receive a first selection for a first player 111. Based on the first selection, the processing service 233 can eliminate any particular player 111 that if subsequently selected for the lineup, will place the combined risk score above the risk score threshold of the desired payout multiplier 121. The processing service 233 can continue to iteratively remove players 111 from the player selection interface 100 based on the correlation score and risk score.

The processing service 233 can auto select a combination of players 111 for a particular lineup based on the desired payout multiplier 121. For example, the processing service 233 can receive a request to generate a complete lineup for the particular client device 203. The processing service 233 can employ the risk score, the correlation score, and/or any other particular metric to select various players and their associated outcomes 122 for the particular lineup. The processing service 233 can send the preselected lineup to the client device 203 for approval. The client device 203 and the player selection interface 100 can allow the user to review the preselected lineup. For example, if the user does not like a particular player 111, the processing service 233 can send various alternative players 111 with similar risk scores and/or correlation scores to the client device 203 for selection to replace the particular player 111.

The client device 203 can submit various other lineups with distinct, similar, or a combination of distinct and similar players 111 and associated events. For example, the client device 203 can submit a plurality of additional lineups individually comprising a respective plurality of selected options of a plurality of options with respective multiplier values that combine to equal the desired payout multiplier 121. The options can correspond to the players 111 and their associated events, the outcomes 122 of the players 111 and their associated events, or a combination thereof. The client device 203 can submit various lineups with equal sizes, distinct sizes, or a combination thereof.

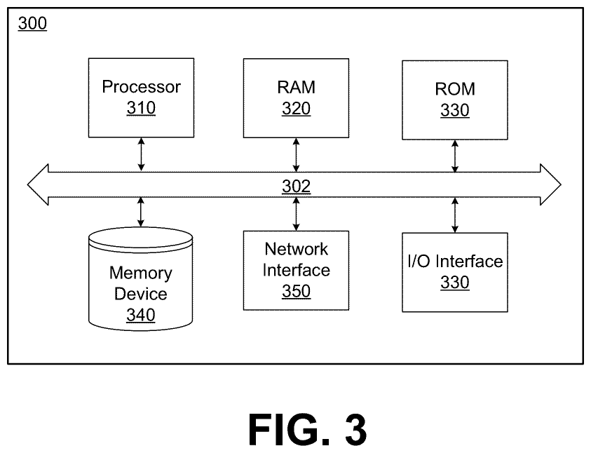

Referring now to FIG. 3, illustrated is a schematic block diagram of the computing environment 201, according to one example of the disclosed systems and methods. The computing environment 201 can include one or more computing devices 300. Each computing device 300 can include at least one processor circuit, for example, having a processor 310 and a memory 340, both of which are coupled to a local interface 302. To this end, each computing device 106 can include, for example, at least one server computer or like device. The local interface 302 can include, for example, a data bus with an accompanying address/control bus or other bus structure as can be appreciated.

Stored in the memory 340 can include both data and several components that are executable by the processor 310. In particular, stored in the memory 340 and executable by the processor 310 can include the management service 212, the client application 216, and potentially other applications. In particular embodiments, also stored in the memory 340 may be a data store 211 and other data. In addition, an operating system can be stored in the memory 340 and executable by the processor 310.

It is understood that there can be other applications that are stored in the memory 340 and are executable by the processor 310 as can be appreciated. Where any component discussed herein is implemented in the form of software, any one of a number of programming languages may be employed such as, for example, C, C++, C #, Objective C, Java®, JavaScript®, Perl, PHP, Visual Basic®, Python®, Ruby, Flash®, or other programming languages.

In particular embodiments, a number of software components are stored in the memory 340 and are executable by the processor 310. In this respect, the term “executable” can mean a program file that is in a form that can ultimately be run by the processor 310. Examples of executable programs can include, for example, a compiled program that can be translated into machine code in a format that can be loaded into a random access portion of the memory 340 and run by the processor 310, source code that may be expressed in a proper format such as object code that is capable of being loaded into a random access portion of the memory 340 and executed by the processor 310, or source code that may be interpreted by another executable program to generate instructions in a random access portion of the memory 340 to be executed by the processor 310, etc. An executable program can be stored in any portion or component of the memory 340 including, for example, random access memory (RAM) 320, read-only memory (ROM) 330, hard drive, solid-state drive, USB flash drive, memory card, optical disc such as compact disc (CD) or digital versatile disc (DVD), floppy disk, magnetic tape, or other memory components.

The memory 340 can be defined herein as including both volatile and nonvolatile memory and data storage components. Volatile components can include those that do not retain data values upon loss of power. Nonvolatile components can include those that retain data upon a loss of power. Thus, the memory 340 can include, for example, random access memory (RAM) 320, read-only memory (ROM) 330, hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM 320 can include, for example, static random access memory (SRAM), dynamic random access memory (DRAM), or magnetic random access memory (MRAM) and other such devices. The ROM 330 can include, for example, a programmable read-only memory (PROM), an erasable programmable read-only memory (EPROM), an electrically erasable programmable read-only memory (EEPROM), or other like memory device.

Also, the processor 310 can represent multiple processors 310 and/or multiple processor cores and the memory 340 can represent multiple memories 340 that operate in parallel processing circuits, respectively. In such a case, the local interface 302, a network interface 350, and/or I/O interface 460 can be an appropriate network that facilitates communication between any two of the multiple processors 310, between any processor 310 and any of the memories 340, or between any two of the memories 340, etc. The local interface 302 can include additional systems designed to coordinate this communication, including, for example, performing load balancing. The processor 310 can be of electrical or of some other available construction.

Although the management service 212, client application 216, and other various systems described herein can be embodied in software or code executed by hardware as discussed above, as an alternative the same can also be embodied in dedicated hardware or a combination of software/hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application-specific integrated circuits (ASICs) having appropriate logic gates, field-programmable gate arrays (FPGAs), or other components, etc.

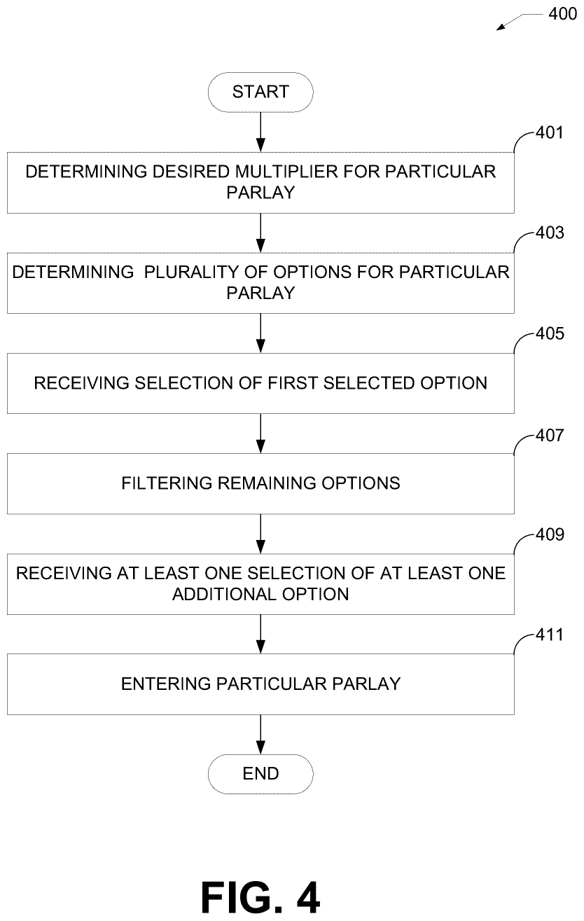

The flowcharts of FIG. 4 show the functionality and operation of an implementation of portions of the management service 212, the client application 216, and/or any other system and/or application distributed across the network 205. If embodied in software, each block can represent a module, segment, or portion of code that includes program instructions to implement the specified logical function(s). The program instructions can be embodied in the form of source code that includes human-readable statements written in a programming language or machine code that can include numerical instructions recognizable by a suitable execution system such as a processor 310 in a computer system or other system. The machine code can be converted from the source code, etc. If embodied in hardware, each block can represent a circuit or a number of interconnected circuits to implement the specified logical function(s).

Although the flowcharts of FIG. 4 show a specific order of execution, it is understood that the order of execution can differ from that which is depicted. For example, the order of execution of two or more blocks can be scrambled relative to the order shown. Also, two or more blocks shown in succession in FIG. 4 may be executed concurrently or with partial concurrence. Further, in some embodiments, one or more of the blocks shown in FIG. 4 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the management service 212 and the client application 216, that can include software or code can be embodied in any non-transitory computer-readable medium for use by or in connection with an instruction execution system such as, for example, a processor 310 in a computer system or other system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media such as, for example, magnetic, optical, or semiconductor media. More specific examples of a suitable computer-readable medium can include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein, including the management service 212 and the client applications 216, can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same client device 203 or in multiple computing devices in the same computing environment 201 or client device 203. Additionally, it is understood that terms such as “application,” “service,” “system,” “engine,” “module,” and so on can be interchangeable and are not intended to be limiting. For example, while specific functionality can be described as happening by a specific application (e.g., the management service 212 and the client applications 216), it us understood that the functionality described may be interchangeable and is not intended to be limiting to a specific component.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Language such as “based on” unless specifically stated otherwise, is otherwise understood to included “based at least in part on.” For the purposes of this application, the term automatically can refer to functionality being performed by a computing device with substantially no user interaction or no user interaction being required.

Referring now to FIG. 4, illustrated is a flowchart of a process 400, according to one example of the disclosed systems and processes. The process 400 can demonstrate a technique for eliminating one or more players 111 for selection in a particular lineup through the player selection interface 100.

At box 401, the process 400 can include determining a desired payout multiplier 121 corresponding to at least one lineup for a particular user account. The processing service 233 can determine the desired payout multiplier 121 corresponding to at least one lineup for the particular user account. The client device 203 can be associated with a user account stored in the user data 221. The client device 203 can send, through the player selection interface 100, the desired payout multiplier 121. The client device 203 can either send a custom payout multiplier 121 received through the input device 214 (e.g., keyboard) or a particular payout multiplier 121 as defined by the player selection interface 100 (e.g., through a drop-down menu). The processing service 233 can receive the desired payout multiplier 121 and associate the desired payout multiplier 121 with the user data 221. The processing service 233 can determine if the desired payout multiplier 121 falls below the multiplier threshold.

At box 403, the process 400 can include determining a plurality of options corresponding to the at least one lineup, wherein each of the plurality of options are associated with the respective multiplier value. The processing service 233 can determine the plurality of options corresponding to the at least one lineup, wherein each of the plurality of options can be associated with the respective multiplier value. The plurality of options can also be referred to as the various associated events of each particular player 111. The processing service 233 can determine players 111 and their associated events that are available for conditional risks. The processing service 233, for example, can extract from the player data 223 historical performance data for the particular player 111 and upcoming sporting events of the particular player 111. The processing service 233 can determine the associated events based on the historical performance data of the particular players 111 and the upcoming sporting events of the particular players 111. The processing service 233 can determine the associated events of the players 111 based on extracted player data 223 from the external resources 206 (e.g., third-party bookmakers). Each of the particular players 111 and their associated events can include the respective multiplier value. The respective multiplier value can be substantially similar to the odds associated with the particular players 111 and their associated events. The processing service 233 can calculate the respective multiplier value for each particular option based on the risk score of the multiplier data 225, the correlation score of the multiplier data 225, and/or any other particular data from the multiplier data 225. Each particular player 111 can be assigned the respective multiplier value to identify the odds associated with the respective player 111. Assigning the respective multiplier value to the player 111 and their associated event can be substantially similar to assigning the risk score to the player 111 and their associated event. In various embodiments, the risk score of the multiplier data 225 can be substantially similar to the respective multiplier value, and vise-versa.

At box 405, the process 400 can include receiving a selection of a first selected option of the plurality of options for the at least one lineup. The computing environment 201 can receive the selection of the first selected option of the plurality of options for the at least one lineup. The client device 203 can receive the selection of the first selected option through the input device 214. The client device 203 can send the selection of the first selection option to the computing environment 201 through the communication service 231.

At box 407, the process 400 can include filtering a plurality of remaining options of the plurality of options based on the desired payout multiplier 121, the respective multiplier of the first selected option, and the respective multiplier for each of the plurality of remaining options. The processing service 233 can filter the plurality of remaining options of the plurality of options based on the desired payout multiplier 121, the respective multiplier of the first selected option, and the respective multiplier for each of the plurality of remaining options. The processing service 233 can employ the respective multipliers of each option (e.g., associated event) for identifying the particular lineup of selected options that will satisfy the desired payout multiplier 121. For example, the processing service 233 can generate a respective weight for each of the particular respective multipliers of the options. The processing service 233 can determine the respective weights based on the risk scores and/or the correlation scores of the multiplier data 225. The processing service 233 can multiply the respective multipliers by the respective weight and sum the products to determine a weighted multiplier for the particular combination of options. In various embodiments, the processing service 233 can generated respective weights equal to 1, such that the respective multipliers are unchanged. The processing service 233 can combine the respective multiplier value for each of the plurality of selected options by multiplying the respective multiplier value for each of the plurality of selected options together. The processing service 233 can reject all options that, when included in the at least one lineup, can generate the weighted multiplier greater than that of the desired multiplier. For example, the player selection interface 100 can remove players 111 that have been removed by the process service 233 based on the desired payout multiplier 121.

The processing service 233 can determine a first multiplier threshold based on dividing the desired payout multiplier 121 by the respective multiplier of the first selected option. The processing service 233 can filter the plurality of remaining options of the plurality of options by removing a subset of the plurality of remaining options with respective multipliers that fail to meet the first multiplier threshold. The processing service 233 can determine a second multiplier threshold based on dividing the desired multiplier by the respective multiplier of the first selected option. The processing service 233 can filter the plurality of remaining options of the plurality of options by removing a subset of the plurality of remaining options with respective multipliers that fail to meet the second multiplier threshold. The processing service 233 can employ the risk score of the multiplier data 225 and the risk score threshold to perform substantially similar processes as the first multiplier threshold, the second multiplier threshold and associated respective multipliers.

The first multiplier threshold can function as an upper multiplier limit threshold and the second multiplier threshold can function as a lower multiplier limit threshold. For example, the processing service 233 can reject players 111 that fall between the upper multiplier limit threshold and the lower multiplier limit threshold. In another example, the processing service 233 can accept players 111 that fall between the upper multiplier limit threshold and the lower multiplier limit threshold.

At box 409, the process 400 can include receiving at least one selection of at least one additional option from the plurality of remaining options for the at least one lineup, wherein the respective multiplier value for each of a plurality of selected options combine to equal the desired payout multiplier 121 and the plurality of selected options comprises the first selected option and the at least one additional option. The computing environment 201 can receive at least one selection of at least one additional option from the plurality of remaining options for the at least one lineup, wherein the respective multiplier value for each of a plurality of selected options combine to equal the desired multiplier and the plurality of selected options comprises the first selected option and the at least one additional option. On reducing the players 111 selectable in the player selection interface 100, the client device 203 can send a subsequent selection for a particular player 111 and their associated event to the computing environment 201. The processing service 233 can determine, based on the sum of the respective multipliers of the selected players 111, if the lineup is acceptable based on the desired payout multiplier 121. For example, the processing service 233 can accept the lineup if the sum of the respective multipliers for each particular selected player 111 equals the desired payout multiplier 121. In another example, the processing service 233 can deny the lineup if the sum of the respective multipliers for each particular selected player 111 equals less than or more than the desired payout multiplier 121.

At box 411, the process 400 can include, enter the at least one lineup for the particular user account with the plurality of selected options. The client device 203 can enter the at least one lineup for the particular user account with the plurality of selected options to the computing environment 201. By entering the at least one lineup, the client device 203 is actively risking the conditional risk 115 for the payout amount 114.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid-state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general-purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general-purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed innovations may be described in the context of computer-executable instructions, such as program modules or engines, as described earlier, being executed by computers in networked environments. Such program modules are often reflected and illustrated by flow charts, sequence diagrams, example screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represents examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed innovation are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An example system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language, or other input devices (not shown), such as a microphone, etc. These and other input devices are often connected to the processing unit through known electrical, optical, or wireless connections.

The computer that affects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the innovations are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the innovation is connected to the local network through a network interface or adapter. When used in a WAN or WLAN networking environment, the computer may include a modem, a wireless link, or other mechanisms for establishing communications over the wide-area network, such as the Internet. In a networked environment, program modules depicted relative to the computer, or portions thereof, may be stored in a remote data storage device. It will be appreciated that the network connections described or shown are example and other mechanisms of establishing communications over wide area networks or the Internet may be used.

While various aspects have been described in the context of a preferred embodiment, additional aspects, features, and methodologies of the claimed innovations will be readily discernible from the description herein, by those of ordinary skill in the art. Many embodiments and adaptations of the disclosure and claimed innovations other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed innovations. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed innovations. In addition, some steps may be carried out simultaneously, contemporaneously, or in synchronization with other steps.

The embodiments were chosen and described in order to explain the principles of the claimed innovations and their practical application so as to enable others skilled in the art to utilize the innovations and various embodiments and with various modifications as are suited to the particular use contemplated. Alternative embodiments will become apparent to those skilled in the art to which the claimed innovations pertain without departing from their spirit and scope. Accordingly, the scope of the claimed innovations is defined by the appended claims rather than the foregoing description and the example embodiments described therein.

What is claimed:

1. A system, comprising:
a data store; and
at least one computing device in communication with the data store, wherein the at least one computing device is configured to:
determine a desired multiplier corresponding to at least one lineup for a particular user account;
determine a plurality of options corresponding to the at least one lineup, wherein each of the plurality of options are associated with a respective multiplier value;
receive a selection of a first selected option of the plurality of options for the at least one lineup;
filter a plurality of remaining options of the plurality of options based on the desired multiplier, the respective multiplier of the first selected option, and the respective multiplier for each of the plurality of remaining options;
receive at least one selection of at least one additional option from the plurality of remaining options for the at least one lineup, wherein the respective multiplier value for each of a plurality of selected options combine to equal the desired multiplier and the plurality of selected options comprises the first selected option and the at least one additional option; and
enter the at least one lineup for the particular user account with the plurality of selected options.

2. The system of claim 1, wherein the at least one computing device is further configured to in response to receiving the at least one additional option, further filter the plurality of remaining options based on the desired multiplier, the respective multiplier of the first selected option, the respective multiplier for the at least one additional option, and the respective multiplier for each of the plurality of remaining options.

3. The system of claim 1, wherein the at least one computing device is further configured to:
determine a first multiplier threshold based on dividing the desired multiplier by the respective multiplier of the first selected option; and
filter the plurality of remaining options of the plurality of options by removing a subset of the plurality of remaining options with respective multipliers that fail to meet the first multiplier threshold.

4. The system of claim 3, wherein the at least one computing device is further configured to:
determine a second multiplier threshold based on dividing the desired multiplier by the respective multiplier of the first selected option; and
filter the plurality of remaining options of the plurality of options by removing a subset of the plurality of remaining options with respective multipliers that fail to meet the second multiplier threshold.

5. The system of claim 4, wherein the first multiplier threshold comprises an upper multiplier limit threshold and the second multiplier threshold comprises a lower multiplier limit threshold.

6. The system of claim 1, wherein the at least one computing device is further configured to combine the respective multiplier value for each of the plurality of selected options by multiplying the respective multiplier value for each of the plurality of selected options together.

7. The system of claim 1, wherein the at least one computing device is further configured to filter a plurality of remaining options of the plurality of options based on a correlation score, wherein the correlation score defines a correlation coefficient between a two or more options.

8. The system of claim 7, wherein the at least one computing device is further configured to reject a combination of the two or more options in response to identifying that the correlation score falls above a correlation score threshold.

9. The system of claim 1, wherein the at least one computing device is further configured to filter a plurality of remaining options of the plurality of options based on a risk score, wherein the risk score quantitates an amount of risk incurred by an operator.

10. The system of claim 9, wherein the at least one computing device is further configured to reject a subset of the plurality of options in response to identifying that the risk score falls above a risk score threshold.

11. A method, comprising:
receiving, via at least one computing device, a selection of a desired multiplier corresponding to at least one lineup for a particular user account;
determining, via the at least one computing device, a plurality of options corresponding to the at least one lineup, wherein each of the plurality of options are associated with a respective multiplier value;
determining, via the at least one computing device, a first selected option of the plurality of options for the at least one lineup;
filtering, via the at least one computing device, a plurality of remaining options of the plurality of options based on the desired multiplier, the respective multiplier of the first selected option, and the respective multiplier for each of the plurality of remaining options;
determining, via the at least one computing device, at least one selection of at least one additional option from the plurality of remaining options for the at least one lineup, wherein the respective multiplier value for each of a plurality of selected options combine to equal the desired multiplier and the plurality of selected options comprises the first selected option and the at least one additional option; and
entering, via the at least one computing device, the at least one lineup for the particular user account with the plurality of selected options.

12. The method of claim 11, further comprising generating, via the at least one computing device, a plurality of additional lineups individually comprising a respective plurality of selected options of the plurality of options with respective multiplier values that combine to equal the desired multiplier.

13. The method of claim 12, wherein a respective count of the respective plurality of selected options for each of the plurality of additional lineups is a same quantity.

14. The method of claim 11, wherein the at least one lineup has a payout value of the desired multiplier times a monetary amount.

15. The method of claim 11, wherein determining the first selected option and the at least one additional option comprising randomly selecting, via the at least one computing device, the first selected option and the at least one additional option one at a time from an increasingly reduced subset of the plurality of options that meeting a threshold criteria for achieving the desired multiplier.

16. A non-transitory computer-readable medium embodying a program that, when executed by at least one computing device, causes the at least one computing device to:
determine a desired multiplier corresponding to at least one lineup for a particular user account;
determine a plurality of options corresponding to the at least one lineup, wherein each of the plurality of options are associated with a respective multiplier value;
receive a selection of a first selected option of the plurality of options for the at least one lineup;
filter a plurality of remaining options of the plurality of options based on the desire multiplier, the respective multiplier of the first selected option, and the respective multiplier for each of the plurality of remaining options;
receive at least one selection of at least one additional option from the plurality of remaining options for the at least one lineup, wherein the respective multiplier value for each of a plurality of selected options combine to equal the desired multiplier and the plurality of selected options comprises the first selected option and the at least one additional option; and
enter the at least one lineup for the particular user account with the plurality of selected options.

17. The non-transitory computer-readable medium of claim 16, wherein a first player associated with the first selected option is associated with a first entity and the at least one additional option is associated with a second entity, the second entity differing from the first entity.

18. The non-transitory computer-readable medium of claim 16, wherein one of the plurality of options comprises a particular threshold statistic for a particular player in a particular contest.

19. The non-transitory computer-readable medium of claim 16, wherein the program further causes the at least one computing device to generate a user interface comprising the plurality of remaining options, wherein the at least one selection is received via the user interface.

20. The non-transitory computer-readable medium of claim 19, wherein the program further causes the at least one computing device to deactivate one or more filtered options of the plurality of remaining options in the user interface.
